(19) United States
(12) Patent Application Publication
(10) Pub. No.: US 2026/0298191 A1
(43) Pub. Date: Oct. 1, 2026

(54) A WAVE ENERGY CONVERTER SYSTEM

(71) Applicants: Aslihan Korez Penley, Aberdeen (GB); ZOEX LTD., Aberdeen (GB)

(72) Inventor: Aslihan Korez Penley, Aberdeen (GB)

(73) Assignee: ZOEX LTD., Aberdeen (GB)

(21) Appl. No.: 19/479,372

(22) PCT Filed: Apr. 28, 2023
(86) PCT No.: PCT/IB2023/054464

§ 371 Date: Oct. 28, 2025

(30) Foreign Application Priority Data
Mar. 7, 2022 (GB) 2203096.9

(51) Int. Cl. F03B 13/18

(52) U.S. Cl. CPC F03B 13/1815; F05B 2240/91

(57) ABSTRACT

This invention relates to a wave energy converter system (1) which is comprised of fenders (10) attached to marine man-made structure (M), such as breakwater/offshore platform/barge/buoy etc., by a link structure (3) and converts 5 the wave motion to clean electricity by direct drive electrical generators attached to said link structure (3).

### TECHNICAL FIELD

This invention relates to a wave energy converter system which is comprised of fender attached to man-made structures by a link structure and converts the wave motion into electricity by generator attached onto said link structure.

### BACKGROUND OF THE INVENTION

The world's continuously increasing energy consumption from fossil fuels causes a huge amount of carbon dioxide emissions which contribute to climate change. This has led researchers and people to search for more sustainable technologies, which does not have the harmful emissions. The renewable energy-based systems such as solar, wind, hydro and biomass is now established however the same success hasn't happened with the vast energy in ocean waves due to high cost.

Wave energy systems need to find a niche market to develop and reduce cost with economies of scale so that they can also join this renewable energy mix. Therefore, we focused our invention on application in several market sectors including breakwaters, marine platforms, maritime, defense, offshore oil and gas, offshore wind, offshore aquaculture and remote coastal communities so that from there with scale of economies, we can drop the cost and join the renewable energy mix. These offshore industries, or another name for it is the “Blue Economy”, uses diesel generators as power and/or auxiliary power which needs to be phased out by 2045 under the UK binding Net Zero Policy. There are not many viable renewable energy alternatives that can replace diesel. These Industries are moving more and more offshore which makes renewable energy from shore (mainland) cable cost prohibitive. There is floating solar, however this does not work in northern latitudes where many of offshore sites are located, there is simply no sun light during winter months. There is small vertical wind solution, however this takes space on the barge/platform and may affect the stability of the barge. Tidal current may or may not be available at the selected site. Therefore, there is an immediate market need for a viable wave energy device to serve these Offshore Industries.

Over the years, many ingenious wave systems have been proposed; some have been built, tested and even demonstrated useful power yet none has so far demonstrated a commercially viable system in operation. For instance, float and buoy systems are used in the state of the art and said float and buoy systems is mounted to the breakwaters. Float and buoy systems in the wave energy systems use the rise and fall of the water body and drive the hydraulic pumps. A series of anchored floats and buoys rise and fall of the wave and said movement is used to run a generator to produce electricity.

In the state of the art, the Chinese patent document no. CN109183712 discloses water tank type floating breakwater for configuring a power generating device, which can effectively absorb and eliminate external wave energy, and can effectively reduce the swing of the breakwater under the impact of waves by the sloshing phenomenon in the water tank. Said water tank type floating breakwater includes a water tank and a plurality of anchor chains are installed outside the water tank, and the water tank is moored to the seabed through the said anchor chain.

In the state of the art, the Chinese patent document no. CN106968871 discloses a multisection floating wave energy electromagnetic generator comprising N electromagnetic power generation sections and a flexible cable respectively. Said multi-section floating type wave energy electromagnetic generator can be used for collecting wave energy in oceans, lakes and rivers, and achieves conversion from wave energy to electric energy along with movement of waves.

In the state of the art, the U.S. Pat. No. 7,956,478B2 discloses a wave power apparatus comprising a plurality of arms, each of which is rotationally supported at one end by a shaft, and wherein each arm carries a float at its other end, which is opposite to the supported end, so that a translational movement of the float caused by a wave results in rotation of the arm around the shaft, the apparatus comprising power conversion means for converting power transmitted from the wave to the arms into electric power.

In the state of the art, one of the problems in the wave energy system is that a viable wave energy device cannot be provided. The existing wave energy systems do not fulfil the generating power effectively in small waves or surviving the most extreme waves. We can describe this problem as the end-stop problem. A mechanical hard stop (or end stop) will result in high structural loading and the potential for catastrophic failure if it acts to retain the free motion of the device. As it is difficult to predict the maximum wave that a given site will experience during the lifetime of a device end stops should be avoided where possible. Said end-stop problem creates a design trade-off between having a sufficiently large range of motion to accommodate extreme waves whilst having adequate resolution to generate efficiently in small sea states.

### SUMMARY OF THE INVENTION

An objective of the present invention is to realize a wave energy converter system comprising of fenders attached to man-made structures with a link structure and converts the wave motion into clean electricity by the generators attached to said link structure.

Another objective of the invention is to realize a wave energy converter system for attaching to man-made marine structures in locations subjected to both wave energy and tidal variation and optimized to extract energy from the smallest waves whilst surviving the most extreme.

Another objective of the present invention is to realize a modular wave energy converter system wherein the fenders are pivoting with a mechanical intensifier mechanism to move through an operating arc of 180 degrees without encountering a mechanical end-stop, whilst concentrating the full working stroke of the generators to a narrow operating angle, e.g. of 15 degrees or less.

Another objective of the present invention is to realize a modular wave energy converter system mounted directly onto a range of marine man-made structures such as breakwaters, jetties, barges, platforms, etc. and wherein the modular units are installed in an array for increased generation capacity.

The invention is as defined in the claims appended hereto and by preferred embodiments thereof described below.

### DETAILED DESCRIPTION OF THE INVENTION

“A Wave Energy Converter System” realized to fulfil the objective of the present invention is shown in the figure attached, in which:

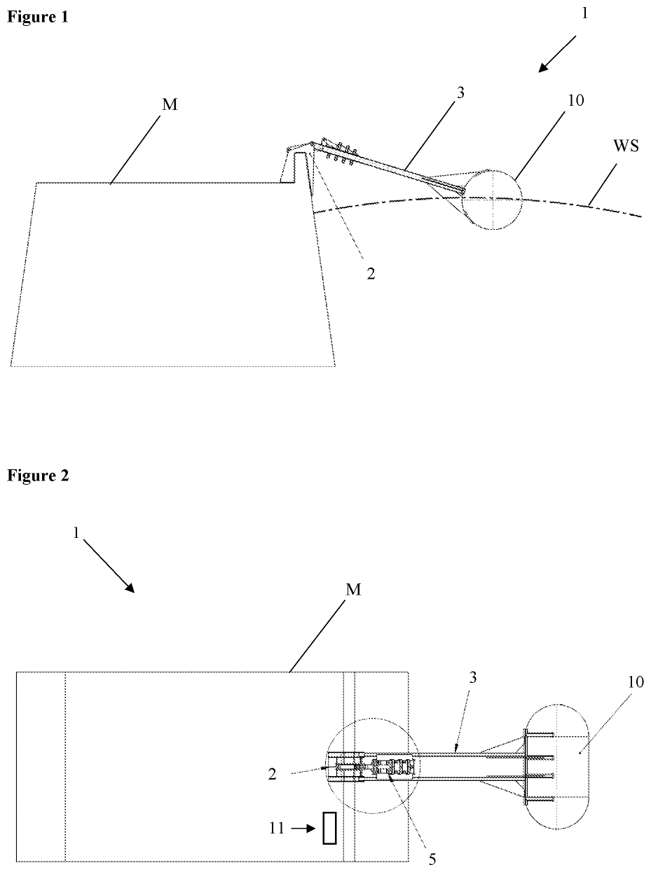

FIG. 1 is a side view of the inventive converter system on the wave surface (WS).

FIG. 2 is a top view of the inventive converter system.

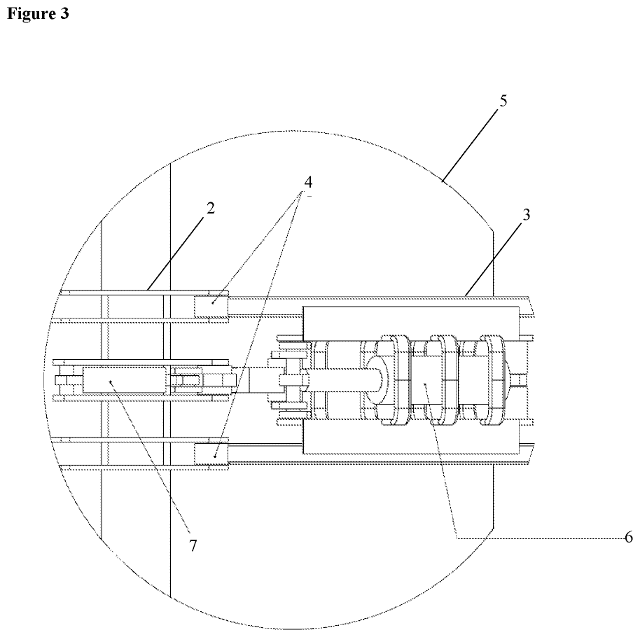

FIG. 3 is a top view of the main bearings, primary actuator and secondary actuator.

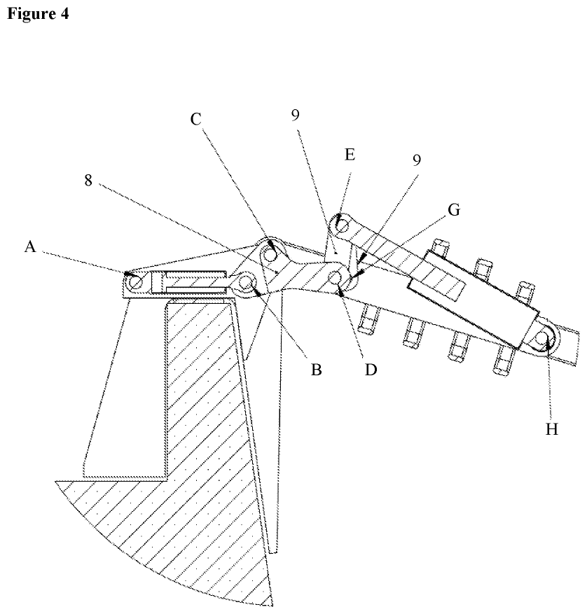

FIG. 4 is a side view of the bearings and links in the PTO module.

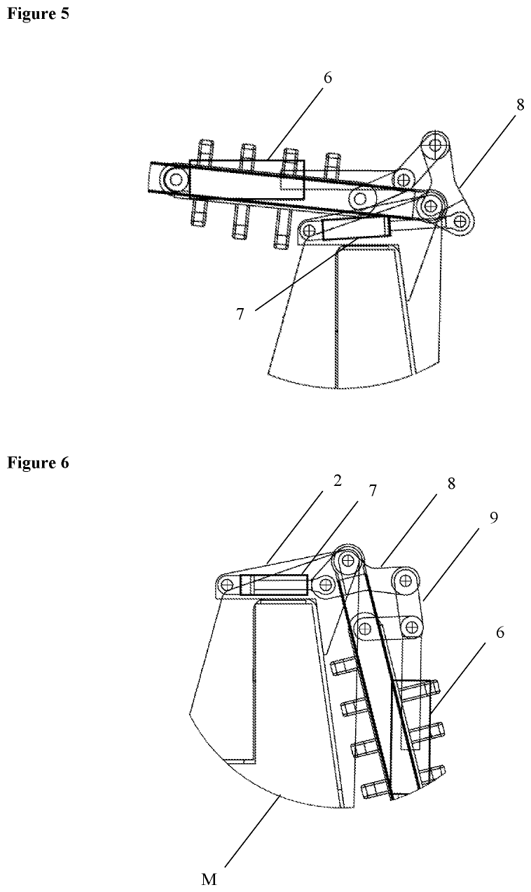

FIG. 5 is a side view of the inventive converter system in maintenance status.

FIG. 6 is a side view of the inventive converter system in submerged status.

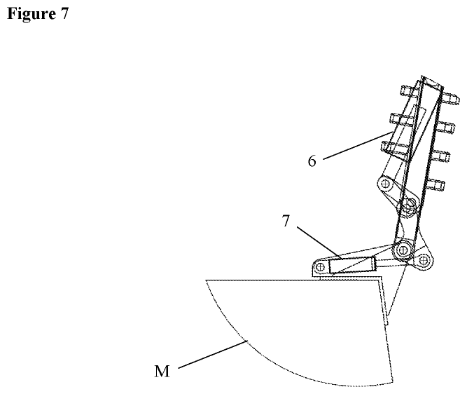

FIG. 7 is the lifted up shape of the inventive converter in maintenance and survivability.

The components illustrated in the figures are individually numbered, where the numbers refer to the following:
1. Converter system
2. Connection element
3. Link structure
4. Main bearing
5. PTO (power take off) module
6. Primary actuator
7. Secondary actuator
8. Rocker
9. Link
10. Fender
11. Electrical and Auxiliary Cabinet
M: Marine Man-made structure
WS: Wave Surface

The inventive wave energy converter system (1) for converting wave motion into electricity comprises:
at least one connection element (2) which is connected to marine man-made structures (M),
at least one link structure (3) which is connected to connection element (2) via at least two main bearing (4),
at least one power take off (PTO) module (5) to convert linear motion to raw electrical output, comprising;
   at least one primary actuator (6) attached to the link structure (3),
   at least one secondary actuator (7) attached to the connection element (2) for tidal tracking,
   at least one rocker (8) attached directly to the secondary actuator (7) and, attached to the primary actuator (6) via a link (9) and
at least one pneumatic fender (10) attached to the link structure (3) by a strapping arrangement.

In the preferred embodiment of the invention, the connection element (2) is the main structural interface element between the link structure (3) and connected marine man-made structure (M). Also, the connection element (2) comprises two hinge points for main bearings (4) for the connection to the link structure (3). In another use of the invention, the connection element (2) comprises a sliding mechanism (not shown on figures) connected to a wall rail. Said sliding mechanism aims to adjust the position of the connection element (3) in relation to the mean waterline level which is affected by the tides. The sliding mechanism comprises four sets of roller assemblies for distribute the hydrodynamic loads from the fender (10) to the wall rails and on the break water structure. The roller assemblies on the sliding mechanism incorporate a breaking mechanism to ensure the position of the carriage at desired level is held in place at the desired vertical position. The sliding mechanism must be locked with said breaking mechanism in place during normal operation and only released periodically to adjust to tidal variation in the mean water level.

In the inventive wave energy converter system (1), the link structure (3) is the main structural element connecting the fender (10) to the main bearings (4). The link structure (3) is rotated with the fender (10) around the main bearing (4) pivot point axis in response to the waves. In the preferred embodiment of the invention, the link structure (3) is fabricated from marine grade steel.

In the preferred embodiment of the inventive system PTO module (5) is removable from the link structure (3). In the PTO module (5), the primary actuator (6) is a direct drive linear generator and connected to both rocker (8) via link (9) and link structure (3). The primary actuator (6) converts the rotary motion of the fender (10) to linear motion. In the preferred embodiment of the invention, the secondary actuator (7) is a hydraulic cylinder and is used to adjust the maximum power point to track the tidal rise and fall. The PTO module (5) comprises a simple double linkage mechanism for gearing and creates a non-linear relationship between the main bearing (4) pivot angle and stroke of the primary actuator (6). The double linkage mechanism is to concrete the working stroke into a small working angle while allowing unrestricted movement through the full range (180 degree) for maintenance and survivability modes.

In the PTO module (5), secondary actuator (7) is attached to connection element (2) from one end via at least one bearing (A). Said secondary actuator (7) is attached from other end to the rocker (8) via at least one bearing (B). The rocker (8) is aligned to main bearings (4) and also attached to link (9) via at least three bearing (C). The said link (9) is attached both the rocker (8) via at least two bearing (D) and the primary actuator (6) via at least four bearing (E).

Also link (9) is attached to PTO module (5) via at least two bearings (G). The primary actuator (6) is attached from other end to link structure (3) via at least two bearing (H). (FIG. 3)

In the preferred embodiment of the invention, the fender (10) is a pneumatic fender and is preferably the main element for absorbing the energy from the waves and, while it may be attached to the link structure by any suitable means is preferably attached to the link structure (3) via the strapping arrangement comprising at least one chain and at least one strap. Said chains attach to both ends of the fenders (10). Said straps wrap around the fenders (10) and fit back to the link structure (3). The strapping arrangement used on the fenders (10) would be attached to the link structure (3) via a shear pin.

In the inventive wave energy converter system (1), the fender (10) is ballasted with the sea water until it submerges against the man-made structure (M) in a survivability status. (FIG. 6). In the submerged status, the hydrostatic force will be reduced although the fender (10) and the link structure (3) and also the hydrostatic force will still be subject to significant dynamic loads. In the submerged position, the fender (10) will make contact with the marine man-made structure (M) (M). In the preferred embodiment of the invention, a buoyancy control module (not shown in the figures) manages the transition from submerged status by floating the fender (10) to bring it back to operational status. In the submerged status of the inventive converter system (1), the primary actuator (6) and secondary actuator (7) is used to damp the response of the fender (10) during the transition.

In the preferred embodiment of the invention, the wave energy converter system (1) also comprises a buoyancy control module (not shown in the figures) used to empty the fender (10). The buoyancy control module is used for recovery of the fender (10) in pinch process. In the recovery (pinch) process the secondary actuator (7) extends, the primary actuator (6) remains locked below the pinch point. Also, the secondary actuator (7) lift the link structure (3) to the vertical position and the fender (10) is lifted in a controlled fashion by the primary actuator (6). (FIG. 7) The inventive wave energy converter system (1) also comprises at least one cabinet (11) for electrical power conditioning systems. Said cabinet (11) is also used for buoyancy control and secondary power packs.

The inventive wave energy convertor system (1) provides sufficient power to weight ratio to justify the considerable cost of installation, transportation and deployment.

The inventive energy converter system (1) provides a solution to the problem of efficiently capturing the kinetic energy in small sea-states by using an innovative mechanical intensifier mechanism design that allows the pivoting fender (10) to move through an operating arc of, for example, 180 degrees (or other suitable substantial operating arc that facilitates stowing, such as at least 90 degrees, more preferably at least 120 degrees and most typically no less than 160 degrees) without encountering a mechanical end-stop, whilst concentrating the full working stroke of the primary generator (6) to a narrower operating angle, e.g. of up to 45 degrees, preferably up to 30 degrees and optimally according to the particular circumstances of the site, such as up to 20 degrees or 15 degrees or less. This simple, yet innovative design offers tangible improvements to the performance of a wave energy converter, particularly in the following areas:
improved survivability-the design eliminated end stop issues providing a more robust long tern solution without requiring active force control to limit motion during extreme wave events.
improved capacity factor-the intensifier increases the working velocity of the primary generator (6) during small sea-states and progressively detunes once the working angle exceeds the design limit. This allows the system (1) to achieve rated power in significantly smaller sea-states than normally possible due to the practical limitations on the amount of reactive load that can be controllably delivered in a system responding with low relative displacement and velocity. Achieving rated power in small sea-states is key to improving the capacity factor and delivering a reduced overall cost of energy.
improved use of primary generator (6) capital expenditure-In many WEC designs, the working stroke (and in some cases the PTO design load) is determined by the survival condition rather than the most commonly occurring operational seastate. This leads to an inefficient use of CAPEX with the primary generator (6) capacity rarely utilised effectively. By contrast the mechanical intensifier design allows the full capacity of the converter system (1) to be utilised even in small sea-states
   Additionally, the present invention provides cuts down the cost by having a connection element (2) that is attachable to any marine man-made structure (M), in a way converting them into a clean energy device. Partially this is also achieved by using a fender (10) as a wave absorber body instead of a metal float, as the fender (10) does not damage the host structure. On the contrary the fender (10) protects the host structure against impact damage and enhances the pitch and roll stability of floating structures thus increasing personnel safety.

It is possible to develop various embodiments of the inventive wave energy converter system (1); the invention cannot be limited to examples disclosed herein and it is essentially according to claims.

1. A wave energy converter system (1) for converting wave motion into electricity comprising;
at least one connection element (2) which is for connection to a marine man-made structure (M),
at least one link structure (3) which is pivotally mounted to the connection element (2) and characterized by;
at least one power take-off (PTO) module (5) for converting linear motion to raw electrical output, the PTO module comprising:
at least one primary actuator (6) attached to the link structure (3);
at least one secondary actuator (7) attached to the connection element (2) for one or more of tidal tracking, maintenance and survivability modes; and
at least one rocker (8) mounted in relation to the secondary actuator (7) and, mounted in relation to the primary actuator (6) via a link (9); and
at least one fender (10) mounted in relation to the link structure (3).

2. A wave energy converter system (1) according to claim 1, wherein the connection element (2), acting as a primary structural interface element between the link structure (3) and the marine man-made structure (M), is connected directly to the marine man-made structure (M).

3. A wave energy converter system (1) according to claim 1 or claim 2, wherein the at least one link structure (3) is pivotally mounted to the connection element (2) by at least two bearings (4).

4. A wave energy converter system (1) according to claim 3; wherein the connection element (2) comprises two hinge points for main bearings (4) for the connection to the link structure (3).

5. A wave energy converter system (1) according to any of the preceding claims, at least one rocker (8) is attached directly to the secondary actuator (7).

6. A wave energy converter system (1) according to any of the preceding claims, which is attached to the primary actuator (6) via a link.

7. A wave energy converter system (1) according to any of the preceding claims, wherein the connection element (2) comprises a sliding mechanism connected to a wall rail.

8. A wave energy converter system (1) according to claim 7, wherein said sliding mechanism is configured to enable adjustment of the position of the connection element (3) in relation to the mean waterline level, which is affected by the tides.

9. A wave energy converter system (1) according to claim 7 or claim 8, wherein the sliding mechanism comprises one or more (preferably four sets of) roller assemblies to distribute the hydrodynamic loads from the fender (10) to the wall rails and to the man-made structure.

10. A wave energy converter system (1) according to claim 9, wherein the one or more roller assemblies on the sliding mechanism incorporates a breaking mechanism to ensure the position of a carriage is held in place at a desired vertical position.

11. A wave energy converter system (1) according to any of the preceding claims, wherein the link structure (3) is configured to be rotated with the fender (10) around a main bearing (4) pivot point axis in response to waves.

12. A wave energy converter system (1) according to any of the preceding claims, wherein the link structure (3) is fabricated from marine grade steel.

13. A wave energy converter system (1) according to any of the preceding claims, wherein the PTO module (5) is removably mounted on the link structure (3).

14. A wave energy converter system (1) according to any of the preceding claims, wherein the primary actuator (6) is a direct drive linear generator and is connected to both rocker (8) via link (9) and link structure (3).

15. A wave energy converter system (1) according to any of the preceding claims, wherein the primary actuator (6) converts the rotary motion of the fender (10) to linear motion.

16. A wave energy converter system (1) according to any of the preceding claims, wherein the secondary actuator (7) is a hydraulic cylinder and is used to adjust the maximum power point to track the tidal rise and fall for maintenance and survival modes.

17. A wave energy converter system (1) according to any of the preceding claims, wherein the PTO module (5) comprises a simple double linkage mechanism for gearing and creates a non-linear relationship between a main bearing (4) pivot angle and a stroke of the primary actuator (6).

18. A wave energy converter system (1) according to any of the preceding claims, wherein the fender is a pneumatic fender.

19. A wave energy converter system (1) according to any of the preceding claims, wherein the fender (10) is the main element absorbing the energy from the waves and is attached to the link structure (3) via a strapping arrangement, which preferably comprises at least one chain and at least one strap.

20. A wave energy converter system (1) according to claim 19, wherein the strapping arrangement comprises chains that attach to both ends of the fenders (10).

21. A wave energy converter system (1) according to claim 19 or claim 20, wherein the strapping arrangement comprises straps which wrap around the fenders (10) and fit back to the link structure (3).

22. A wave energy converter system (1) according to any of the preceding claims, wherein the fender (10) is ballasted with the sea water until it submerges against the marine man-made structure (M) in a survivability status.

23. A wave energy converter system (1) according to any of the preceding claims, which comprises a buoyancy control module configured to empty the fender (10) and bring it back to an operational mode.

24. A wave energy converter system (1) according to claim 23, wherein the buoyancy control module manages the transition from submerged status by floating the fender (10).

25. A wave energy converter system (1) according to any of the preceding claims, which comprises at least one cabinet (11) for electrical power conditioning systems.

26. A wave energy converter system (1) according to any of the preceding claims, wherein the at least one connection element (2) is connected to a marine man-made structure (M).
